(19) United States
(12) Patent Application Publication
(10) Pub. No.: US 2022/0305978 A1
(43) Pub. Date: Sep. 29, 2022

(54) EXPANDED MOBILE HOME AND RECREATIONAL VEHICLE USING SAME

(71) Applicant: EBS RV Technology Co., Ltd, Foshan Guangdong (CN)

(72) Inventor: Michel Alain MARQUETON, Foshan Guangdong (CN)

(21) Appl. No.: 17/658,208

(22) Filed: Apr. 6, 2022

Related U.S. Application Data
(63) Continuation of application No. PCT/CN2020/117851, filed on Sep. 25, 2020.

(30) Foreign Application Priority Data
Oct. 8, 2019 (CN) 201910950164.3

(51) Int. Cl. B60P 3/34

(52) U.S. Cl. CPC B60P 3/34

(57) ABSTRACT

The present disclosure discloses an expanded mobile home and a recreational vehicle using the same. The main body comprises top roof and underframe, the side of main body is expansion member, expansion member comprises upper compartment body, lower compartment body which are sleeved, upper compartment body is provided below the top roof, linear bearing shaft and linear bearing block are provided between upper compartment body and top roof, lower compartment body provided on underframe, second guide groove are provided between the lower compartment body and underframe. First driving device on the main body drives expansion member to horizontally expand and retract with respect to main body, second driving device provided in lower compartment body drives upper compartment body, lower compartment body to expand and contract vertically, mobile home can be reduced in volume as much as possible when leaving facilitates transportation. The mobile home is expanded when arriving at the destination, which saves time and labor, more convenient for users.

### CROSS-REFERENCE TO RELATED APPLICATIONS

This application is a continuation of co-pending International Patent Application No. PCT/CN2020/117851, filed on Sep. 25, 2020, which claims the priority and benefit of Chinese patent application number 201910950164.3, filed Oct. 8, 2019 with China National Intellectual Property Administration, the entire contents of which are incorporated herein by reference.

### TECHNICAL FIELD

The present disclosure relates to the field of mobile homes, in particular to an expanded mobile home and a recreational vehicle using the same.

### BACKGROUND

At present, in construction sites or other places, mobile homes are the main way to quickly build residences for users. The existing mobile homes are mainly mobile board houses, which mainly take advantage of simple structure and easy quick assembly of boards. However, materials still need to be transported to the target location first, and then mobile homes can be manually assembled, which requires more manpower and material resources.

Recreational vehicle gradually becomes a new way of life. Considering the volume required for life and convenient transportation, the existing recreational vehicles are being improved in the direction of expansion. However, recreational vehicles on the market, at present, mainly expand and retract in one direction, either up and down or left and right or front and back, but cannot expand and retract at the same time in vertical and horizontal directions. The existing recreational vehicles that can expand and retract at the same time are only theoretically feasible, but in real use, when the main compartment and the expansion compartment retract or expand vertically and horizontally, it is easy to get stuck because of the tilt error resulted from the main compartment and the expansion compartment in the reverse direction, and it is completely abandoned by the market due to frequent accidents. Therefore, the height of the existing recreational vehicle is set according to the actual demand, and it is high and not small enough when leaving the factory, and it will occupy a larger space during transportation.

### SUMMARY

In order to solve the above technical problems, the purpose of the present disclosure is to provide a movable house which can be effectively expanded and retracted on 2 axis, or a recreational vehicle using the same.

The technical scheme used by the present disclosure to solve the problem is as follows: an expanded movable house comprises:

a main body comprising an underframe and a top roof, wherein the underframe is movable vertically with respect to the top roof;

at least one expansion member, wherein the expansion member is provided on the side of the main body, the side of the expansion member facing the main body is open, the expansion member is capable of being horizontally expanded and retracted with respect to the main body, the expansion member comprises an upper compartment body with a lower opening and a lower compartment body with an upper opening, the bottom of the low compartment body is provided on the underframe, the upper compartment body is provided below the top cover, the upper compartment body and the lower compartment body are sleeved with each other, and the upper compartment body is capable of lifting vertically with respect to the low compartment body;

a linear bearing shaft, wherein the linear bearing shaft is provided at the top of the upper compartment body or the bottom of the top roof, the bottom of the top roof or the top of the upper compartment body is provided with a linear bearing block which is in transition fit with the linear bearing shaft, and the linear bearing shaft is only movable in the horizontal direction along the linear bearing block;

a second guide rod, wherein the linear bearing shaft is provided at the bottom of the lower compartment body or the top of the underframe, and the top of the underframe or the bottom of the lower compartment body is provided with a second guide groove which is in transition fit with the second guide rod;

a first driving device, wherein the first driving device is provided on the main body and is configured to drive the expanding member to horizontally expand and retract with respect to the main body;

at least two second driving devices, wherein the second driving devices are symmetrically provided in the lower compartment body, the output ends of the second driving devices are connected with the upper compartment body, and the second driving devices are configured to drive the upper compartment body to move vertically with respect to the lower compartment body.

As a further improvement of the above technical scheme, four second driving devices are provided in the lower compartment body, and the four second driving devices are symmetrically provided at four corners of the lower compartment body.

As a further improvement of the above technical scheme, the lower compartment body is square, four corners of the lower compartment body are provided with a fixing rod, respectively, an installation hole penetrates through the fixing rod, the second driving device is installed in the installation hole, and the second driving device is in transition fit with the installation groove.

As a further improvement of the above technical scheme, a first wallboard and a second wallboard are provided on the part of the main body where the expansion member is not provided, the first wallboard is provided below the top roof and is connected with the top cover, the second wallboard is provided above the underframe and is connected with the underframe, the first wallboard is sleeved outside the second wallboard, and at least one side of the first wallboard and the second wallboard is provided with a movable door.

As a further improvement of the above technical scheme, there are two expansion members, and the two expansion members are provided on the left and right sides of the main body.

As a further improvement of the above technical scheme, a telescopic support column is provided between the top roof and the bottom cover, an opening and closing door is provided at the front end and/or the back end of the main body, the opening and closing door is provided on the top cover, the opening and closing door is capable of being turned over with respect to the top cover, the width of the opening and closing door is the farthest distance between the two lower compartment bodies, one end of the two lower compartment bodies close to each other is provided with an expansion and retraction door, the expansion and contraction door is provided at the side wall edge of the lower compartment body, and the expansion door is rotatable with respect to the side edge of the lower compartment body so as to close the vacancy generated when the lower compartment body expands.

As a further improvement of the above technical scheme, the first driving device and the second driving device are electric rods or hydraulic rods.

As a further improvement of the above technical scheme, the bottom of the lower compartment body is further provided with a telescopic supporting leg, the telescopic supporting leg is capable of expanding out of the bottom of the lower compartment body and is supported on the ground.

A recreational vehicle, comprising a vehicle body, wherein the vehicle body is further equipped with the expansion mobile homes according to any one of the above schemes.

As a further improvement of the above technical scheme, the bottom of the expanded mobile home is further provided with a movable wheel, the rear end of the vehicle body is provided with a connection port, and the front end of the expanded mobile home is provided with a hook which is matchable with the connection port.

The present disclosure has the beneficial effects that: the side of the main body is provided with an expansion member, the expansion member comprises an upper compartment body and a lower compartment body which are sleeved with each other, the upper compartment body is provided below the top cover, a linear bearing shaft and a linear bearing block are provided between the upper compartment body and the top cover, the upper compartment body and the top roof are connected integrally through the stabilization and connection of the linear bearing shaft and the linear bearing block, the lower compartment body is provided on the underframe, and a second guide rod and a second guide groove are provided between the lower compartment body and the underframe, so as to play the role of orientation and reducing friction force, ensure the stability between the lower compartment body and the underframe, and make it easier for the expanding member to horizontally expand and retract with respect to the main body. Then, a first driving device provided on the main body drives the expansion member to horizontally expand and retract with respect to the main body, the second driving device is provided in the lower compartment body, the output end of the second driving device is provided on the upper compartment body, and the positions of the upper compartment body and the lower compartment body are further positioned and lifted by the second driving device. When in use, the second driving device drives the upper compartment body to rise, thus raising the height. The first driving device drives the expansion member to expand and retract horizontally, thus expanding the space of the mobile home. Therefore, this product can be reduced in the horizontal and height directions twice when leaving the factory, thus reducing the volume as much as possible and facilitating transportation. The mobile home is then expanded when arriving at the destination, which saves time and labor without consuming extra labor. In this manner of expansion and retraction, a part of furniture can be installed in the mobile home when leaving the factory, which can be used after expansion, making it more convenient for users to use.

At the same time, because the second driving device directly drives the upper compartment body to move, the movement of the upper compartment body and the lower compartment body is very stable, and it is not easy to get stuck. Because the top roof is connected with the upper compartment body through the linear bearing shaft and the linear bearing block, the upper compartment body will drive the top roof to move vertically together when moving vertically. Moreover, through the positioning functions of the linear bearing shaft and the linear bearing block at the top and the second guide rod and the second guide groove at the bottom, even if the deviation between the upper compartment body and the lower compartment body has a very small amplitude, the amplitude is only between the error between the second guide rod and the second guide groove and the error between the linear bearing shaft and the linear bearing block, so that the upper compartment body and the lower compartment body will not get stuck. The recreational vehicle using this product can effectively fill the gap of retracting recreational vehicles in the market, and solve the current situation that the prior art cannot be actually produced.

### BRIEF DESCRIPTION OF THE DRAWINGS

The present disclosure will be further explained with reference to the accompanying drawings and specific embodiments hereinafter.

FIG. 1 is a schematic structural diagram during expanded according to a preferred embodiment of the present disclosure.

FIG. 2 is a schematic structural diagram of a sectional plane in the A-A direction of FIG. 1.

FIG. 3 is a schematic structural diagram during retraction according to a preferred embodiment of the present disclosure.

FIG. 4 is a schematic structural diagram of a sectional plane in the B-B direction of FIG. 3.

FIG. 5 is a schematic structural diagram of a top roof according to a preferred embodiment of the present disclosure.

FIG. 6 is a schematic structural diagram of an expanding member according to a preferred embodiment of the present disclosure.

### DETAILED DESCRIPTION OF THE EMBODIMENTS

This section will describe the specific embodiments of the present disclosure in detail. The preferred embodiments of the present disclosure are shown in the drawings. The purpose of the drawings is to supplement the description in the text part of the specification with graphics, so that people can intuitively and vividly understand every technical feature and the overall technical scheme of the present disclosure, but it cannot be understood as limiting the scope of protection of the present disclosure.

In the description of the present disclosure, it should be understood that the orientation or positional relationship indicated by terms related to the orientation description such as up, down, front, back, left, right, etc. is based on the orientation or positional relationship shown in the drawings, only for the convenience of describing the present disclosure and simplifying the description, rather than indicate or imply that the indicated device or element must have a specific orientation, be constructed and operated in a specific orientation, so that it cannot be understood as a limitation of the present disclosure.

In the description of the present disclosure, “several” means one or more, and many means more than two, and “a plurality of” means two or more. “Greater than”, “less than”, “more than”, etc. are understood as excluding this number. “above”, “below”, “within”, etc. are understood as including this number. If the description of a first and a second is only used to distinguish technical features, it cannot be understood as indicating or implying relative importance or implicitly indicating the number of indicated technical features or implicitly indicating the sequence of indicated technical features.

In the description of the present disclosure, unless otherwise explicitly limited, the words such as providing, installing and connecting should be understood broadly, and the those skilled in the art can reasonably determine the specific meanings of the above words in the present disclosure in combination with the specific contents of the technical scheme.

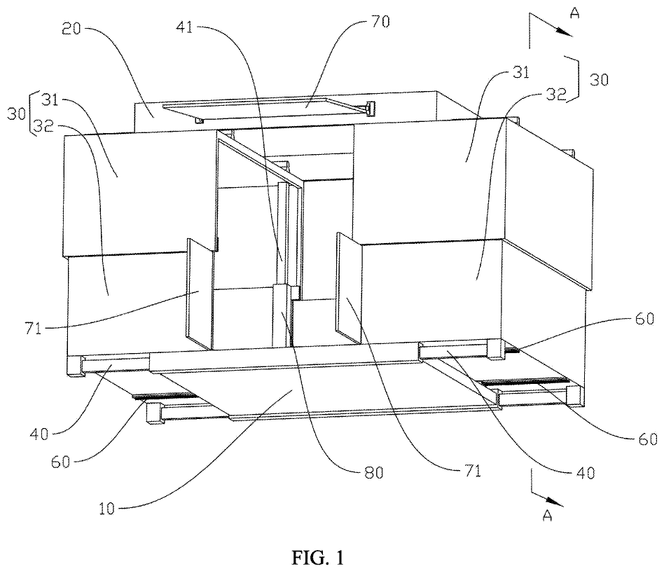

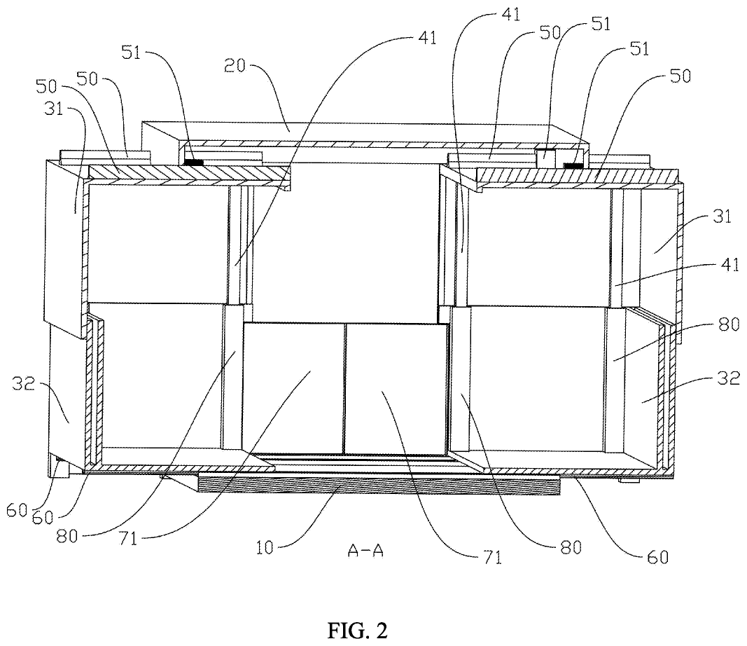

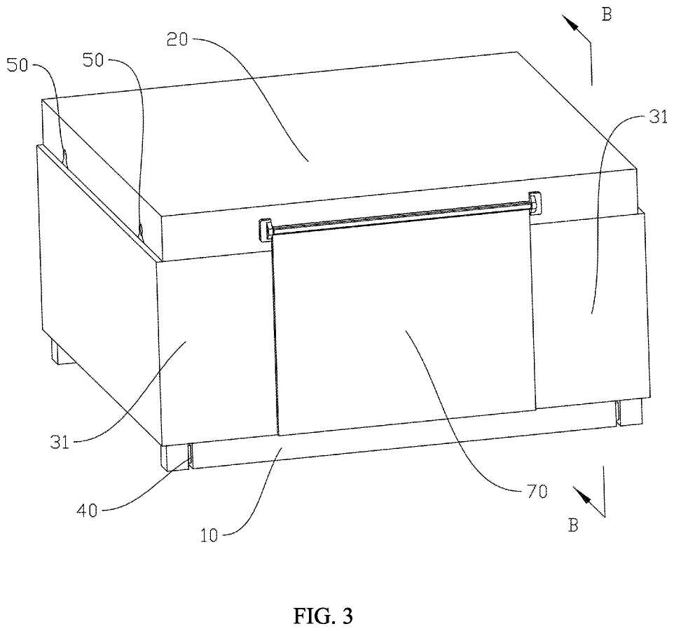

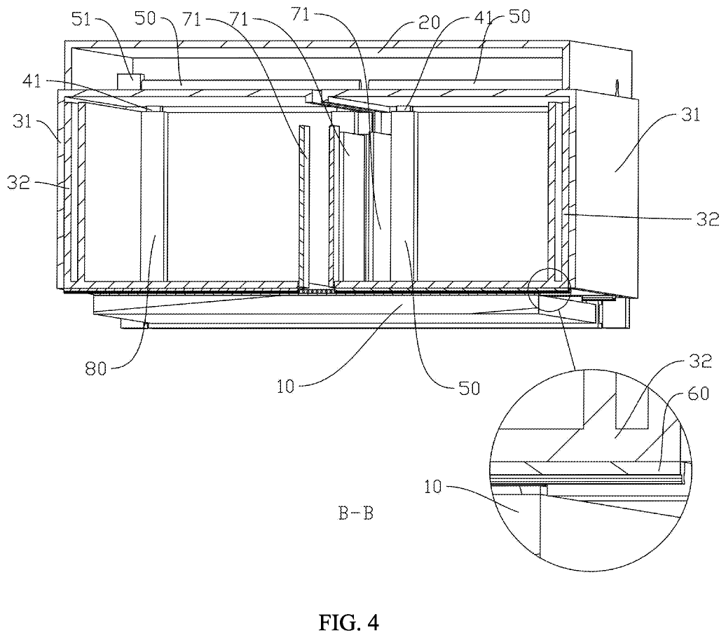

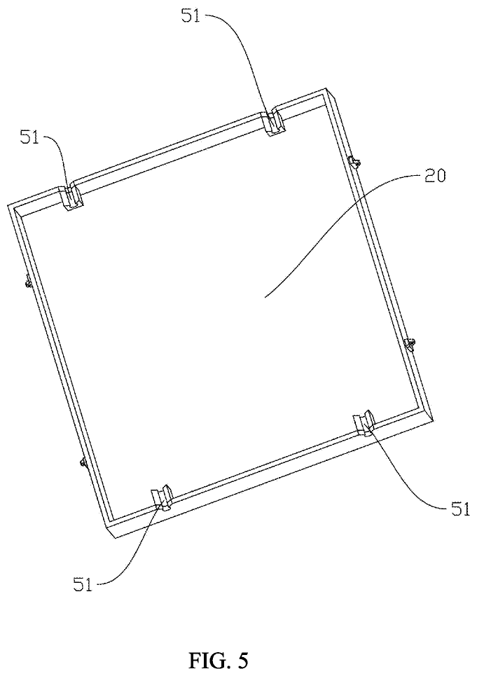

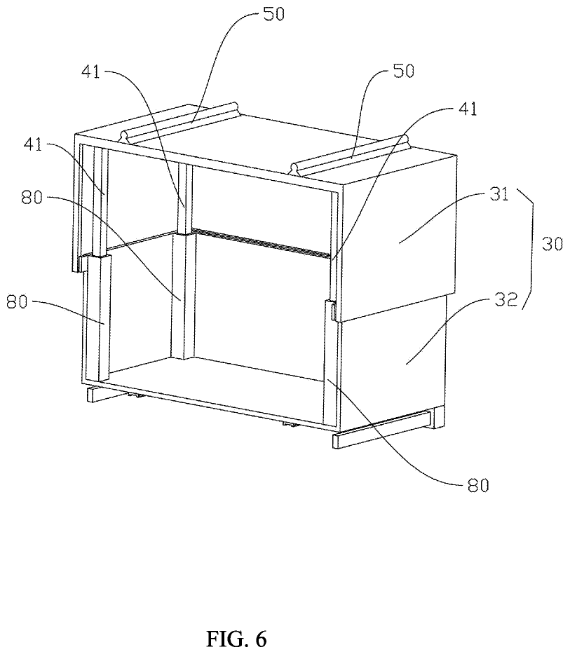

Referring to FIG. 1 to FIG. 6, an expanded mobile home comprises:

a main body comprising an underframe 10 and a top roof 20, wherein the underframe 10 is movable vertically with respect to the top roof 20;

at least one expansion member 30, wherein the expansion member 30 is provided on the side of the main body, the side of the expansion member 30 facing the main body is open, the expansion member 30 is capable of being horizontally expanded and retracted with respect to the main body, the expansion member 30 comprises an upper compartment body 31 with a lower opening and a lower compartment body 32 with an upper opening, the bottom of the low compartment body 32 is provided on the underframe 10, the upper compartment body 31 is provided below the top roof 20, the upper compartment body 31 and the lower compartment body 32 are sleeved with each other, and the upper compartment body 31 is capable of lifting vertically with respect to the low compartment body 32;

a linear bearing shaft 50, wherein the linear bearing shaft 50 is provided at the top of the upper compartment body 31 or the bottom of the top roof 20, and the bottom of the top roof 20 or the top of the upper compartment body 31 is provided with a linear bearing block 51 which is in transition fit with the linear bearing shaft 50;

a second guide rod, wherein the linear bearing shaft 50 is provided at the bottom of the lower compartment body 32 or the top of the underframe 10, and the top of the underframe 10 or the bottom of the lower compartment body 32 is provided with a second guide groove which is in transition fit with the second guide rod;

a first driving device 40, wherein the first driving device 40 is provided on the main body and is configured to drive the expanding member 30 to horizontally expand and retract with respect to the main body;

at least two second driving devices 41, wherein the second driving devices 41 are symmetrically provided in the lower compartment body 32, the output ends of the second driving devices 41 are connected with the upper compartment body 31, and the second driving devices 41 are configured to drive the upper compartment body 31 to move vertically with respect to the lower compartment body 32.

The side of the main body is provided with an expansion member 30, the expansion member 30 comprises an upper compartment body 31 and a lower compartment body 32 which are sleeved with each other, the upper compartment body 31 is provided below the top roof 20, a linear bearing shaft 50 and a linear bearing block 51 are provided between the upper compartment body 31 and the top roof 20, the upper compartment body 31 and the top roof 20 are connected integrally through the stabilization and connection of the linear bearing shaft 50 and the linear bearing block 51, the lower compartment body 32 is provided on the underframe 10, and a second guide rod and a second guide groove are provided between the lower compartment body 32 and the underframe 10, so as to play the role of orientation and reducing friction force, ensure the stability between the lower compartment body 32 and the underframe 10, and make it easier for the expanding member 30 to horizontally expand and retract with respect to the main body. Then, a first driving device 40 provided on the main body drives the expansion member 30 to horizontally expand and retract with respect to the main body, the second driving device 41 is provided in the lower compartment body 32, the output end of the second driving device 41 is provided on the upper compartment body 31, and the positions of the upper compartment body and the lower compartment body 32 are further positioned and lifted by the second driving device 41. When in use, the second driving device 41 drives the upper compartment body 31 to rise, thus raising the height. The first driving device 40 drives the expansion member 30 to expand and retract horizontally, thus expanding the space of the mobile home. Therefore, this product can be reduced in the horizontal and height directions twice when leaving the factory, thus reducing the volume as much as possible and facilitating transportation. The mobile home is then expanded when arriving at the destination, which saves time and labor without consuming extra labor. In this manner of expansion and retraction, a part of furniture can be installed in the mobile home when leaving the factory, which can be used after expansion, making it more convenient for users to use.

At the same time, because the second driving device 41 directly drives the upper compartment body 31 to move, the movement of the upper compartment body 31 and the lower compartment body 32 is very stable, and it is not easy to get stuck. Because the top roof 20 is connected with the upper compartment body 31 through the linear bearing shaft 50 and the linear bearing block 51, the upper compartment body 31 will drive the top roof 20 to move vertically together when moving vertically. Moreover, through the positioning functions of the linear bearing shaft 50 and the linear bearing block 51 at the top and the second guide rod and the second guide groove at the bottom, even if the deviation between the upper compartment body 31 and the lower compartment body 32 has a very small amplitude, the amplitude is only between the error between the linear bearing shaft 50 and the linear bearing block 51 and the error between the second guide rod and the second guide groove, so that the upper compartment body 31 and the lower compartment body 32 will not get stuck.

In the above scheme, in order to enable the expanding member 30 to move smoothly on the underframe 10, the second guide rod and the second guide groove are preferably implemented by a sliding rail 60, so that the expanding member 30 can move smoothly on the underframe 10 with less friction. Of course, the linear bearing shaft 50 and the linear bearing block 51 can also use the embodiment of the sliding rail 60 and other embodiments, such as the embodiment of using bearings as the linear bearing block 51 or the second guide groove. In this scheme, the specific embodiments of the linear bearing shaft 50, the linear bearing block 51, the second guide rod and the second guide groove can be other shapes and styles, which are not specifically limited here. The styles and shapes can be changed according to local conditions according to actual demands.

In the above scheme, preferably, the upper compartment body 31 is sleeved outside the lower compartment body 32, which can avoid problems that sand and gravel fall into the gap between the upper compartment body and the lower compartment body 32 and water is accumulated due to weather problems outdoors. Preferably, the linear bearing block 51 is provided at the bottom of the top roof 20, and the linear bearing shaft 50 is provided at the top of the upper compartment body 31.

In a further improvement, preferably, four second driving devices 41 are provided in the lower compartment body 32, and the four second driving devices 41 are symmetrically provided at four corners of the lower compartment body 32. Therefore, when the upper compartment body 31 is driven to move vertically, the upper compartment body 31 is more evenly stressed and is not easy to deform.

In a further improvement, preferably, both the upper compartment body 31 and the lower compartment body 32 are square, four corners of the lower compartment body 32 are provided with a fixing rod 80, respectively, an installation hole penetrates through the fixing rod 80, the second driving device 41 is installed in the installation hole, and the second driving device 41 is in transition fit with the installation groove. Therefore, the fixing rod 80 can further strengthen the second driving device 41, ensuring the stability of the second driving device 41 when driving the upper compartment body 31 to move without shaking due to its own length.

In a further improvement, in the above scheme, the top roof 20 can move vertically with respect to the underframe 10. Preferably, a first wallboard and a second wallboard are provided on the part of the main body where the expansion member 30 is not provided, the first wallboard is provided below the top roof 20 and is connected with the top roof 20, the second wallboard is provided above the underframe 10 and is connected with the underframe 10, the first wallboard is sleeved outside the second wallboard, and at least one side of the first wallboard and the second wallboard is provided with a movable door. The first wallboard is sleeved on the second wallboard, so that the top roof 20 and the underframe 10 can only move vertically, and the overall sealing performance is stronger. The first wallboard and the second wallboard close the part where the expansion member 30 is provided, so that the privacy of the product is stronger. Moreover, the indoor space during use can be further expanded by the enclosure of the first wallboard and the second wallboard.

In the above scheme, preferably, there are two expansion members 30, and the two expansion members 30 are provided on the left and right sides of the main body, so that one of the two expansion members 30 can be expanded to the left and the other expansion member can be expanded to the right. The first wallboard and the second wallboard in front of or behind the main body can be provided with the above-mentioned movable doors, so that it is more beautiful and practical as a whole.

Of course, it is also possible not to use the first wallboard and the second wallboard to enclose on the outside. However, in this way, in order to make the top roof 20 and the bottom cover only move vertically, a telescopic support column needs to be provided between the top roof 20 and the bottom cover for positioning. At this time, preferably, an opening and closing door 70 is provided at the front end and/or the back end of the main body, the opening and closing door 70 is provided on the top roof 20, the opening and closing door 70 is capable of being turned over with respect to the top roof 20, the width of the opening and closing door 70 is the farthest distance between the two lower compartment bodies 32, one end of the two lower compartment bodies 32 close to each other is provided with an expansion and retraction door 71, the expansion and retraction door 71 is provided at the side wall edge of the lower compartment body 32, and the expansion door 71 is rotatable with respect to the side edge of the lower compartment body 32 so as to close the vacancy generated when the lower compartment body 32 expands. When in use, when being expanded, the two expansion members 30 are expanded and raised with respect to both sides of the main body. At this time, a passage into the room is formed between the two expansion members 30. The opening and closing door 70 can close the upper half of the passage, and the expansion and retraction door 71 can close the lower half of the passage. When this scheme is completely retracted, the expansion door 71 is first pushed into the lower compartment body 32 in a rotating manner, and then the expansion members 30 on both sides move towards each other and retract to a minimum. At this time, the opening and closing door 70 will be located outside the side wall of the same side of the two expansion members 30.

In this scheme, the first driving device 40 and the second driving device 41 are preferably electric rods or hydraulic rods. Other driving modes can also be selected, such as driving using a sprocket wheel and driving using a motor, which can also be realized. However, certain faults may easily occur when using, such as chain breakage when using a sprocket wheel.

In a further improvement, because the place where the product is used is not necessarily in good condition, in order to prevent some problems caused by the direct contact between the mobile home and the ground, preferably, the bottom of the lower box body 32 is further provided with a telescopic supporting leg, and the telescopic supporting leg is capable of expanding out of the bottom of the lower compartment body 32 and is supported on the ground, so that the height of the mobile home can be raised and supported by the supporting leg when necessary, and the stability of the mobile home can be adjusted.

The patent of the present disclosure further discloses a recreational vehicle using the above scheme, which comprises a vehicle body, wherein the vehicle body is further equipped with the expansion mobile homes according to any one of above schemes.

Preferably, the installation mode is that the bottom of the expanded mobile home is further provided with a movable wheel, the rear end of the vehicle body is provided with a connection port, and the front end of the expanded mobile home is provided with a hook which is matchable with the connection port, thereby directly forming a towing mode.

Alternatively, an expansion frame can be provided in the vehicle body, and the expanded mobile home can be directly installed on the expansion frame to form a structure similar to the existing truck.

As the expanded mobile home has the characteristics that the expanded mobile home is not easy to get stuck, so that it can smoothly expand and retract in the horizontal and height directions, and after being applied to the recreational vehicle, the expanded mobile home effectively fills the defect that the existing recreational vehicle cannot expand in both horizontal and vertical directions, solving the current situation that the prior art cannot be actually produced, and making the market selectivity more diversified.

The above is only the preferred embodiment of the present disclosure, and rather than limit the patent scope of the present disclosure. Under the inventive concept of the present disclosure, the equivalent structural changes made by using the contents of the present description and drawings or directly or indirectly applied in other related technical fields are all included in the patent protection scope of the present disclosure.

What is claimed is:

1. An expanded mobile home, comprising:
a main body comprising an underframe (10) and a top roof (20), wherein the underframe (10) is movable vertically with respect to the top roof (20);
at least one expansion member (30), wherein the expansion member (30) is provided on the side of the main body, the side of the expansion member (30) facing the main body is open, the expansion member (30) is capable of being horizontally expanded and retracted with respect to the main body, the expansion member (30) comprises an upper compartment body (31) with a lower opening and a lower compartment body (32) with an upper opening, the bottom of the low compartment body (32) is provided on the underframe (10), the upper compartment body (31) is provided below the top roof (20), the upper compartment body (31) and the lower compartment body (32) are sleeved with each other, and the upper compartment body (31) is capable of lifting vertically with respect to the low compartment body (32);
a linear bearing shaft (50), wherein the linear bearing shaft (50) is provided at the top of the upper compartment body (31) or the bottom of the top roof (20), and the bottom of the top roof (20) or the top of the upper compartment body (31) is provided with a linear bearing block (51) which is in transition fit with the linear bearing shaft (50);
a second guide rod, wherein the linear bearing shaft (50) is provided at the bottom of the lower compartment body (32) or the top of the underframe (10), and the top of the underframe (10) or the bottom of the lower compartment body (32) is provided with a second guide groove which is in transition fit with the second guide rod;
a first driving device (40), wherein the first driving device (40) is provided on the main body and is configured to drive the expanding member (30) to horizontally expand and retract with respect to the main body;
at least two second driving devices (41), wherein the second driving devices (41) are symmetrically provided in the lower compartment body (32), the output ends of the second driving devices (41) are connected with the upper compartment body (31), and the second driving devices (41) are configured to drive the upper compartment body (31) to move vertically with respect to the lower compartment body (32).

2. The expanded mobile home according to claim 1, wherein:
four second driving devices (41) are provided in the lower compartment body (32), and the four second driving devices (41) are symmetrically provided at four corners of the lower compartment body (32).

3. The expanded mobile home according to claim 2, wherein:
the lower compartment body (32) is square, four corners of the lower compartment body (32) are provided with a fixing rod (80), respectively, an installation hole penetrates through the fixing rod (80), the second driving device (41) is installed in the installation hole, and the second driving device (41) is in transition fit with the installation groove.

4. The expanded mobile home according to claim 1, wherein:
a first wallboard and a second wallboard are provided on the part of the main body where the expansion member (30) is not provided, the first wallboard is provided below the top roof (20) and is connected with the top roof (20), the second wallboard is provided above the underframe (10) and is connected with the underframe (10), the first wallboard is sleeved outside the second wallboard, and at least one side of the first wallboard and the second wallboard is provided with a movable door.

5. The expanded mobile home according to claim 1, wherein:
there are two expansion members (30), and the two expansion members (30) are provided on the left and right sides of the main body.

6. The expanded mobile home according to claim 5, wherein:
a telescopic support column is provided between the top roof (20) and the bottom cover, an opening and closing door (70) is provided at the front end and/or the back end of the main body, the opening and closing door (70) is provided on the top roof (20), the opening and closing door (70) is capable of being turned over with respect to the top roof (20), the width of the opening and closing door (70) is the farthest distance between the two lower compartment bodies (32), one end of the two lower compartment bodies (32) close to each other is provided with an expansion and retraction door (71), the expansion and retraction door (71) is provided at the side wall edge of the lower compartment body (32), and the expansion door (71) is rotatable with respect to the side edge of the lower compartment body (32) so as to close the vacancy generated when the lower compartment body (32) expands.

7. The expanded mobile home according to claim 1, wherein:
the first driving device (40) and the second driving device (41) are electric rods or hydraulic rods.

8. The expanded mobile home according to claim 1, wherein:
the bottom of the lower compartment body (32) is further provided with a telescopic supporting leg, the telescopic supporting leg is capable of expanding out of the bottom of the lower compartment body (32) and is supported on the ground.

9. A recreational vehicle, comprising a vehicle body, wherein the vehicle body is further equipped with the expansion mobile homes according to claim 1.

10. The recreational vehicle according to claim 9, wherein:
the bottom of the expanded mobile home is further provided with a movable wheel, the rear end of the vehicle body is provided with a connection port, and the front end of the expanded mobile home is provided with a hook which is matchable with the connection port.
